(19) United States
(12) Patent Application Publication
(10) Pub. No.: US 2016/0135066 A1
(43) Pub. Date: May 12, 2016

(54) Method and Device for Calculating Reference Signal Received Power

(71) Applicant: TELEFONAKTIEBOLAGET L M ERICSSON (publ), Stockholm (SE)

(72) Inventors: Baicheng XU, Nuremberg (DE); Jing MA, Beijing (CN)

(21) Appl. No.: 14/408,297

(22) PCT Filed: Mar. 7, 2014
(86) PCT No.: PCT/CN2014/073049

§ 371 Date: Dec. 16, 2014

(51) Int. Cl. H04W 24/08; H04L 25/02; H04J 11/00; H04B 17/318; H04B 17/345

(52) U.S. Cl. CPC H04W 24/08; H04B 17/318; H04B 17/345; H04J 11/0023; H04L 25/0204; H04L 25/0228

(57) ABSTRACT

The present invention provides a method and a device for calculating RSRP. The method comprises the steps of: calculating a first signal power estimation value, the first signal power estimation value being an average value of power of all received RSs; calculating a second signal power estimation value, the second signal power estimation value being an average value of power of all coherence blocks, and the power of each coherence block being the power of an average value of the channel estimation for all the RSs in the coherence block; determining a noise power estimation value according to the first signal power estimation value and the second signal power estimation value; and determining the RSRP according to the first signal power estimation value and the noise power estimation value, or according to the second signal power estimation value and the noise power estimation value.

### TECHNICAL FIELD

The present invention relates to the field of communication technology, in particular to a method and a device for calculating reference signal received power.

### BACKGROUND

RSRP (Reference Signal Received Power) is one of the standard measurement items for an LTE (Long Term Evolution) system. As defined in the specifications, RSRP refers to a linear average value of power of REs (Resource Elements) carrying RSs (Reference Signals) within the considered measurement frequency bandwidth and measurement time.

Referring to FIG. 1, a reference signal R0 (a reference signal transmitted via an antenna port 0) is used for calculating the RSRP. If a UE can accurately detect that a reference signal R1 (a reference signal transmitted via an antenna port 1) is valid, the RSRP may also be calculated by using R0 and R1.

An existing RSRP calculation method comprises the following steps. At first, channel estimation is performed on the received RSs using the following equation: ĥ_{l,k}=r_{l,k}s_{l,k}, wherein, l represents a serial number of RS OFDM (Orthogonal Frequency Division Multiplexing) symbol in time domain, k represents a serial number of RS subcarrier in frequency domain, ĥ_{l,k} represents the channel estimation of the l^{th} RS in time domain and the k^{th} RS in frequency domain, r_{l,k} represents the l^{th} received RS symbol in time domain and the k^{th} received RS in frequency domain, s_{l,k} represents a transmitted RS, and (•)* represents a conjugation operator. Then, the RSRP is calculated in accordance with the channel estimation ĥ_{l,k}.

In order to reduce a channel estimation error, it is required to perform an averaging process on the channel estimation ĥ_{l,k} of all the RSs within the coherence time and the coherence bandwidth. Usually, a fixed length is used in the prior art as the coherence time and the coherence bandwidth. For example, in the LTE system, usually a RB (Resource Block) is used as a coherence block, i.e., a frequency domain width of one RB is used as the coherence bandwidth, and a time width of one RB is used as the coherence time.

The optimal coherence time and coherence bandwidth depend on a wireless channel environment, which may vary at any time. In the worst condition, for example, merely the minimum coherence time (one RS symbol in time domain) and the minimum coherence bandwidth (two adjacent RS symbols in frequency domain) may be used for ETU300 channel, so as to ensure sufficient well correlation between RS sample points for the averaged channel estimation. However, such RS sample points are very few, so it is difficult to obtain the accurate channel estimation, which will result in a big RSRP estimation error. In addition, an existing scheme is very sensitive to the frequency deviation and Doppler frequency, and this also results in an inaccurate RSRP measurement result in a real wireless communication network.

### SUMMARY

An object of embodiments herein is to provide a method and a device for calculating RSRP, so as to calculate the RSRP reliably.

In one aspect, embodiments herein provide a method for calculating RSRP, comprising:

calculating a first signal power estimation value, the first signal power estimation value being an average value of power of all received RSs;

calculating a second signal power estimation value, the second signal power estimation value being an average value of power of all coherence blocks, and the power of each coherence block being power of an average value of the channel estimation for all the RSs in the coherence block;

determining a noise power estimation value according to the first signal power estimation value and the second signal power estimation value; and

determining the RSRP according to the first signal power estimation value and the noise power estimation value, or according to the second signal power estimation value and the noise power estimation value,

wherein the coherence block consists of all REs within coherence time and a coherence bandwidth, a size of the coherence block depends on a current wireless channel environment, or a minimum coherence block consisting of two adjacent RSs in frequency domain and one RS symbol in time domain is used.

Preferably, the first signal power estimation value is calculated using the following equation:

$$\hat{P} = \frac{1}{LK} ( {\sum }_{l = 0}^{L - 1} {β}_{l} {\sum }_{k = 0}^{K - 1} {\vert {\hat{h}}_{l , k} \vert}^{2} )$$

wherein \hat{P} represents the first signal power estimation value, L represents the number of OFDM symbols carrying the RSs for calculating the RSRP, K represents the number of subcarriers carrying the RSs for calculating the RSRP, K=2N_{RB}, N_{RB} represents the number of RBs in frequency domain for calculating the RSRP, l represents a serial number of the RS OFDM symbol in time domain, k represents a serial number of the RS subcarrier in frequency domain, βₗ represents a coefficient of the l^{th} RS OFDM symbol for compensating a gain of down-link chain, the gain of down-link chain refers to a gain of ĥ_{l,k} relative to an antenna port signal, and ĥ_{l,k} represents the channel estimation value of the l^{th} RS in time domain and the k^{th} RS in frequency domain.

Preferably, the second signal power estimation value is calculated using the following equation:

$$\overline{P} = \frac{1}{⌊ L \text{/} M ⌋ ⌊ K \text{/} N ⌋} ( {\sum }_{l = 0}^{⌊ L / M ⌋ - 1} {\sum }_{k = 0}^{⌊ K / N ⌋ - 1} {\vert \frac{\sqrt{{β}_{lM + m}}}{MN} {\sum }_{m = 0}^{M - 1} {\sum }_{n = 0}^{N - 1} {\hat{h}}_{lM + m , kN + n} \vert}^{2} )$$

wherein P̅ represents the second signal power estimation, L represents the number of OFDM symbols carrying the RSs for calculating the RSRP, K represents the number of subcarriers carrying the RSs for calculating the RSRP, M represents the number of RSs in each coherence block in time domain, m represents a serial number of the RS in each coherence block in time domain, N represents the number of RSs in each coherence block in frequency domain, n represents a serial number of the RS in each coherence block in frequency domain, l represents a serial number of the RS OFDM symbol in time domain, k represents a serial number of the RS subcarrier in frequency domain, β_{lM+m} represents a coefficient of the (lM+m)^{th} RS OFDM symbol for compensating a gain of down-link chain, the gain of down-link chain refers to a gain of ĥ_{l,k} relative to the antenna port signal, ĥ_{lM+m,kN+n} represents the channel estimation value of the (lM+m)^{th} RS in time domain and the (kN+n)^{th} RS in frequency domain, and └•┘ represents round-down operation.

Preferably, in the step of determining the noise power estimation value according to the first signal power estimation value and the second signal power estimation value, the noise power estimation value is calculated using the following equation:

$${δ}^{2} = \frac{MN}{MN - 1} ( \hat{P} - \overline{P} )$$

wherein δ² represents the noise power estimation value, \hat{P} represents the first signal power estimation value, P̅ represents the second signal power estimation value, M represents the number of RSs in each coherence block in time domain, and N represents the number of RSs in each coherence block in frequency domain.

Preferably, in the step of determining the RSRP according to the first signal power estimation value and the noise power estimation value, the RSRP is calculated using the following equation:

RSRP=\hat{P}−δ²

wherein δ² represents the noise power estimation value, and \hat{P} represents the first signal power estimation value.

Preferably, in the step of determining the RSRP according to the second signal power estimation value and the noise power estimation value, the RSRP is calculated using the following equation:

RSRP=P̅−δ²/MN

wherein δ² represents the noise power estimation value, P̅ represents the second signal power estimation value, M represents the number of RSs in each coherence block in time domain, and N represents the number of the RSs in each coherence block in frequency domain.

In another aspect, embodiments herein further provide a device for calculating RSRP, comprising:

a first calculation unit, configured to calculate a first signal power estimation value, the first signal power estimation value being an average value of power of all received RSs;

a second calculation unit configured to calculate a second signal power estimation value, the second signal power estimation value being an average value of power of all coherence blocks, and the power of each coherence block being power of an average value of the channel estimation for all the RSs in the coherence block;

a noise power estimation unit, configured to determine a noise power estimation value according to the first signal power estimation value and the second signal power estimation value; and

a RSRP determination unit, configured to determine the RSRP according to the first signal power estimation value and the noise power estimation value, or according to the second signal power estimation value and the noise power estimation value,

wherein the coherence block consists of all REs within coherence time and a coherence bandwidth, a size of the coherence block depends on a current wireless channel environment, or a minimum coherence block consisting of two adjacent RSs in frequency domain and one RS symbol in time domain is used.

Preferably, the first calculation unit is configured to calculate the first signal power estimation value by using the following equation:

$$\hat{P} = \frac{1}{LK} ( {\sum }_{l = 0}^{L - 1} {β}_{l} {\sum }_{k = 0}^{K - 1} {\vert {\hat{h}}_{l , k} \vert}^{2} )$$

wherein \hat{P} represents the first signal power estimation value, L represents the number of OFDM symbols carrying the RSs for calculating the RSRP, K represents the number of subcarriers carrying the RSs for calculating the RSRP, K=2N_{RB}, N_{RB} represents the number of RBs in frequency domain for calculating the RSRP, l represents a serial number of the RS OFDM symbol in time domain, k represents a serial number of the RS subcarrier in frequency domain, βₗ represents a coefficient of the l^{th} RS OFDM symbol for compensating a gain of down-link chain, the gain of down-link chain refers to a gain of ĥ_{l,k} relative to an antenna port signal, and ĥ_{l,k} represents the channel estimation value of the l^{th} RS in time domain and the k^{th} RS in frequency domain.

Preferably, the second calculation unit is configured to calculate the second signal power estimation value by using the following equation:

$$\overline{P} = \frac{1}{⌊ L \text{/} M ⌋ ⌊ K \text{/} N ⌋} ( {\sum }_{l = 0}^{⌊ L / M ⌋ - 1} {\sum }_{k = 0}^{⌊ K / N ⌋ - 1} {\vert \frac{\sqrt{{β}_{lM + m}}}{MN} {\sum }_{m = 0}^{M - 1} {\sum }_{n = 0}^{N - 1} {\hat{h}}_{lM + m , kN + n} \vert}^{2} )$$

wherein P̅ represents the second signal power estimation, L represents the number of OFDM symbols carrying the RSs for calculating the RSRP, K represents the number of subcarriers carrying the RSs for calculating the RSRP, M represents the number of RSs in each coherence block in time domain, m represents a serial number of the RS in each coherence block in time domain, N represents the number of RSs in each coherence block in frequency domain, n represents a serial number of the RS in each coherence block in frequency domain, l represents a serial number of the RS OFDM symbol in time domain, k represents a serial number of the RS subcarrier in frequency domain, β_{lM+m} represents a coefficient of the (lM+m)^{th} RS OFDM symbol for compensating a gain of down-link chain, the gain of down-link chain refers to a gain of ĥ_{l,k} relative to the antenna port signal, ĥ_{lM+m,kN+n} represents the channel estimation value of the (lM+m)^{th} RS in time domain and the (kN+n)^{th} RS in frequency domain, and └•┘ represents round-down operation,

Preferably, the noise power estimation unit is configured to calculate the noise power estimation value by using the following equation:

$${δ}^{2} = \frac{MN}{MN - 1} ( \hat{P} - \overline{P} )$$

wherein δ² represents the noise power estimation value, \hat{P} represents the first signal power estimation value, P̅ represents the second signal power estimation value, M represents the number of RSs in each coherence block in time domain, and N represents the number of RSs in each coherence block in frequency domain.

Preferably, the RSRP determination unit is configured to calculate the RSRP by using the following equation:

RSRP=\hat{P}−δ²

wherein δ² represents the noise power estimation value, and \hat{P} represents the first signal power estimation value.

Preferably, the RSRP determination unit is configured to calculate the RSRP by using the following equation:

RSRP=P̅−δ²/MN

wherein δ² represents the noise power estimation value, P̅ represents the second signal power estimation value, M represents the number of RSs in each coherence block in time domain, and N represents the number of the RSs in each coherence block in frequency domain.

Embodiments herein have the following advantages. The size of the coherence blocks for calculating the RSRP depends on the current wireless channel environment. For RSRP estimation, the size of coherence block can be either detected based on current wireless channel or determined by minimum coherence size, two adjacent RSs in frequency domain and one RS symbol in time domain. As a result, it is able to reliably estimate the RSRP in any channel environment and to obviously improve the performance of a fading channel. In addition, the scheme of embodiments with minimum coherence block herein is no longer sensitive to the frequency deviation and Doppler frequency.

### BRIEF DESCRIPTION OF THE DRAWINGS

FIG. 1 is a schematic view showing the distribution of RSs in REs;

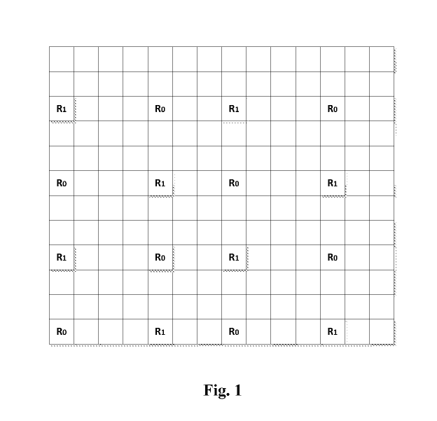

FIG. 2 is a flow chart of a method for calculating RSRP; and

FIG. 3 is a block diagram showing a device for calculating RSRP.

### DETAILED DESCRIPTION

Some basic concepts involved in embodiments herein will be briefly described at first.

The coherence block consists of all REs within the coherence time and the coherence bandwidth. According to the wireless communication theory, the RSs within the coherence bandwidth and the coherence time have an identical or similar channel state. The coherence time refers to a time interval within which there is strong correlation between amplitudes of received signals, i.e., the channel impulse response within the coherence time substantially remains unchanged. The coherence bandwidth refers to a frequency domain bandwidth within which there is strong correlation between the amplitudes of the received signals, i.e., the channel amplitude-frequency response within the coherence bandwidth substantially remains unchanged.

Embodiments herein will be described hereinafter in conjunction with the drawings and the embodiments.

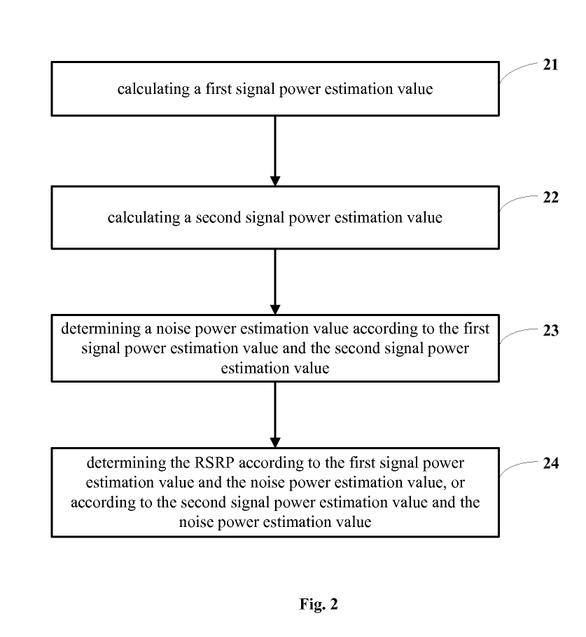

FIG. 2 is a flow chart of a method for calculating RSRP. As shown in FIG. 2, the method for calculating RSRP comprises the following steps:

Step S21: calculating a first signal power estimation value, the first signal power estimation value being an average value of power of all received RSs;

Step S22: calculating a second signal power estimation value, the second signal power estimation value being an average value of power of all coherence blocks, and the power of each coherence block being the power of an average value of the channel estimation for all the RSs in the coherence block;

Step S23: determining a noise power estimation value according to the first signal power estimation value and the second signal power estimation value; and

Step S24: determining the RSRP according to the first signal power estimation value and the noise power estimation value, or according to the second signal power estimation value and the noise power estimation value.

The coherence block consists of all REs within the coherence time and the coherence bandwidth, a size of the coherence block may depend on a current wireless channel environment, or a minimum coherence block consisting of two adjacent RSs in frequency domain and one RS symbol in time domain may be used.

A size of the coherence block may be determined by detecting the current wireless channel environment in real time, or determined by the minimum coherence time (one RS symbol in time domain) and the minimum coherence bandwidth (two adjacent RS symbols in frequency domain).

In the method, at first the coherence bandwidth and the coherence time may be estimated, and all the received RSs may be divided into coherence blocks (i.e., the size of the coherence block may be determined). If the coherence bandwidth and the coherence time are not estimated in advance, as a conservative approach, a minimum coherence block consisting of two adjacent RSs in frequency domain may also be used.

In the above embodiments, the size of the coherence blocks for calculating the RSRP depends on the current wireless channel environment. For RSRP estimation, the size of coherence block can be either detected based on current wireless channel or determined by minimum coherence size, two adjacent RSs in frequency domain and one RS symbol in time domain. As a result, it is able to reliably estimate the RSRP in any channel environment and to obviously improve the performance of a fading channel. In addition, the scheme of embodiments with minimum coherence block herein is no longer sensitive to the frequency deviation and Doppler frequency.

The first signal power estimation value may be calculated using the following equation:

$$\hat{P} = \frac{1}{LK} ( {\sum }_{l = 0}^{L - 1} {β}_{l} {\sum }_{k = 0}^{K - 1} {\vert {\hat{h}}_{l , k} \vert}^{2} )$$

wherein \hat{P} represents the first signal power estimation value, L represents the number of OFDM symbols carrying the RSs for calculating the RSRP, K represents the number of subcarriers carrying the RSs for calculating the RSRP, K=2N_{RB}, N_{RB} represents the number of RBs in frequency domain for calculating the RSRP, l represents a serial number of the RS OFDM symbol in time domain, k represents a serial number of the RS subcarrier in frequency domain, βₗ represents a coefficient of the l^{th} RS OFDM symbol for compensating a gain of down-link chain, the gain of down-link chain refers to a gain of ĥ_{l,k} relative to an antenna port signal, and ĥ_{l,k} represents the channel estimation value of the l^{th} RS in time domain and the k^{th} RS in frequency domain.

The second signal power estimation value may be calculated using the following equation:

$$\overline{P} = \frac{1}{⌊ L \text{/} M ⌋ ⌊ K \text{/} N ⌋} ( {\sum }_{l = 0}^{⌊ L / M ⌋ - 1} {\sum }_{k = 0}^{⌊ K / N ⌋ - 1} {\vert \frac{\sqrt{{β}_{lM + m}}}{MN} {\sum }_{m = 0}^{M - 1} {\sum }_{n = 0}^{N - 1} {\hat{h}}_{lM + m , kN + n} \vert}^{2} )$$

wherein P̅ represents the second signal power estimation, L represents the number of OFDM symbols carrying the RSs for calculating the RSRP, K represents the number of subcarriers carrying the RSs for calculating the RSRP, M represents the number of RSs in each coherence block in time domain, m represents a serial number of the RS in each coherence block in time domain, N represents the number of RSs in each coherence block in frequency domain, n represents a serial number of the RS in each coherence block in frequency domain, l represents a serial number of the RS OFDM symbol in time domain, k represents a serial number of the RS subcarrier in frequency domain, β_{lM+m} represents a coefficient of the (lM+m)^{th} RS OFDM symbol for compensating a gain of down-link chain, the gain of down-link chain refers to a gain of ĥ_{l,k} relative to the antenna port signal, ĥ_{lM+m,kN+n} represents the channel estimation value of the (lM+m)^{th} RS in time domain and the (kN+n)^{th} RS in frequency domain, and └•┘ represents round-down operation.

When each of L/M and K/N is an integer, the second signal power estimation value may be calculated using the following equation:

$$\overline{P} = \frac{MN}{LK} ( {\sum }_{l = 0}^{L / M - 1} {\sum }_{k = 0}^{K / N - 1} {\vert \frac{\sqrt{{β}_{IM + m}}}{MN} {\sum }_{m = 0}^{M - 1} {\sum }_{n = 0}^{N - 1} {\hat{h}}_{lM + m , kN + n} \vert}^{2} )$$

The noise power estimation value may be calculated using the following equation:

$${δ}^{2} = \frac{MN}{MN - 1} ( \hat{P} - \overline{P} )$$

wherein δ² represents the noise power estimation value, \hat{P} represents the first signal power estimation value, P̅ represents the second signal power estimation value, M represents the number of RSs in each coherence block in time domain, and N represents the number of RSs in each coherence block in frequency domain.

The RSRP may be calculated using the following equation:

RSRP=\hat{P}−δ²,

wherein δ² represents the noise power estimation value, and \hat{P} represents the first signal power estimation value.

The RSRP may also be calculated using the following equation:

RSRP=P̅−δ²/MN

wherein δ² represents the noise power estimation value, P̅ represents the second signal power estimation value, M represents the number of RSs in each coherence block in time domain, and N represents the number of the RSs in each coherence block in frequency domain.

In the above embodiments, the RB consists of a plurality REs. For example, in the case of a normal cyclic prefix, each RB consists of 12 (the number of subcarriers)*7 (the number of symbols) REs, and in the case of an extended cyclic prefix, each RB consists of 12 (the number of subcarriers)*6 (the number of symbols) REs.

The method for calculating RSRP of embodiments herein will be described hereinafter by taking an LTE system as an example.

In the LTE system, the method for calculating RSRP comprises the following steps.

Step S31: calculating a first signal power estimation value \hat{P}, the calculation may use the following equation:

$$\hat{P} = \frac{1}{LK} ( {\sum }_{l = 0}^{L - 1} {β}_{l} {\sum }_{k = 0}^{K - 1} {\vert {\hat{h}}_{l . k} \vert}^{2} )$$

wherein \hat{P} represents the first signal power estimation value, L represents the number of OFDM symbols carrying the RSs for calculating the RSRP, K represents the number of subcarriers carrying the RSs for calculating the RSRP, K=2N_{RB}, N_{RB} represents the number of RBs in frequency domain for calculating the RSRP, l represents a serial number of the RS OFDM symbol in time domain, k represents a serial number of the RS subcarrier in frequency domain, βₗ represents a coefficient of the l^{th} RS OFDM symbol for compensating a gain of down-link chain, the gain of down-link chain refers to a gain of ĥ_{l,k} relative to an antenna port signal, and ĥ_{l,k} represents the channel estimation value of the l^{th} RS in time domain and the k^{th} RS in frequency domain.

Step S32: calculating a second signal power estimation value P̅, the calculation may use the following equation:

$$\hat{P} = \frac{N}{LK} ( {\sum }_{l = 0}^{L - 1} {β}_{l} {\sum }_{k = 0}^{( K / N ) - 1} {\vert \frac{1}{N} {\sum }_{n = 0}^{N - 1} {\hat{h}}_{l , kN + n} \vert}^{2} )$$

wherein P̅ represents the second signal power estimation, L represents the number of OFDM symbols carrying the RSs for calculating the RSRP, K represents the number of subcarriers carrying the RSs for calculating the RSRP, K=2N_{RB}, N_{RB} represents the number of RBs in frequency domain for calculating the RSRP, N represents the number of RSs in each coherence block in frequency domain, n represents a serial number of the RS in each coherence block in frequency domain, l represents a serial number of the RS OFDM symbol in time domain, k represents a serial number of the RS subcarrier in frequency domain, βₗ represents a coefficient of the l^{th} RS OFDM symbol for compensating a gain of down-link chain, the gain of down-link chain refers to a gain of ĥ_{l,k} relative to the antenna port signal, and ĥ_{l,kN+n} represents the channel estimation value of the l^{th} RS in time domain and the (kN+n)^{th} RS in frequency domain.

In the embodiments, the number of RSs Min each coherence block in time domain is 1.

Step S33: determining a noise power estimation value according to the first signal power estimation value \hat{P} and the second signal power estimation value P̅ the determination may use the following equation:

$${δ}^{2} = \frac{N}{N - 1} ( \hat{P} - \overline{P} )$$

wherein δ² represents the noise power estimation value, \hat{P} represents the first signal power estimation value, and P̅ represents the second signal power estimation value.

Step S34: determining the RSRP according to the first signal power estimation value and the noise power estimation value, the determination may use the following equation:

RSRP=\hat{P}−δ²

wherein δ² represents the noise power estimation value, and \hat{P} represents the first signal power estimation value.

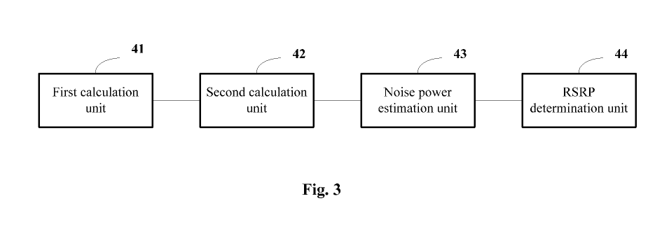

As shown in FIG. 3, embodiments herein further provide a device for calculating RSRP, comprises:

a first calculation unit 41, configured to calculate a first signal power estimation value, the first signal power estimation value being an average value of power of all received RSs;

a second calculation unit 42, configured to calculate a second signal power estimation value, the second signal power estimation value being an average value of power of all coherence blocks, and the power of each coherence block being the power of an average value of the channel estimation for all the RSs in the coherence block;

a noise power estimation unit 43, configured to determine a noise power estimation value according to the first signal power estimation value and the second signal power estimation value; and

an RSRP determination unit 44, configured to determine the RSRP according to the first signal power estimation value and the noise power estimation value, or according to the second signal power estimation value and the noise power estimation value.

The coherence block consists of all REs within the coherence time and the coherence bandwidth, a size of the coherence block may depend on a current wireless channel environment, or a minimum coherence block consisting of two adjacent RSs in frequency domain may be used.

A size of the coherence block may be determined by detecting the current wireless channel environment in real time, or obtained through simulation in advance, or determined on the basis of experiences, or optimized through a test result.

The device may further comprise a coherence bandwidth and coherence time estimation unit configured to estimate the coherence bandwidth and the coherence time and divide all the received RSs into coherence blocks (i.e., to determine the size of the coherence block). If without such coherence bandwidth and coherence time estimation unit, as a conservative approach, a minimum coherence block consisting of two adjacent RSs in frequency domain may also be used.

In the above embodiments, even if the minimum coherence time/coherence bandwidth is used, the coherence block for calculating the RSRP can work reliably. As a result, it is able to reliably estimate the RSRP in any channel environment and to obviously improve the performance of a fading channel. In addition, the device of embodiments herein is no longer sensitive to the frequency deviation and the Doppler frequency.

The first signal power estimation value may be calculated by the first calculation unit 41 using the following equation:

$$\hat{P} = \frac{1}{LK} ( {\sum }_{l = 0}^{L - 1} {β}_{l} {\sum }_{k = 0}^{K - 1} {\vert {\hat{h}}_{l , k} \vert}^{2} )$$

wherein \hat{P} represents the first signal power estimation value, L represents the number of OFDM symbols carrying the RSs for calculating the RSRP, K represents the number of subcarriers carrying the RSs for calculating the RSRP, K=2N_{RB}, N_{RB} represents the number of RBs in frequency domain for calculating the RSRP, l represents a serial number of the RS OFDM symbol in time domain, k represents a serial number of the RS subcarrier in frequency domain, βₗ represents a coefficient of the l^{th} RS OFDM symbol for compensating a gain of down-link chain, the gain of down-link chain refers to a gain of ĥ_{l,k} relative to an antenna port signal, and ĥ_{l,k} represents the channel estimation value of the l^{th} RS in time domain and the k^{th} RS in frequency domain.

The second signal power estimation value may be calculated by the second calculation unit 42 using the following equation:

$$\overline{P} = \frac{1}{⌊ L \text{/} M ⌋ ⌊ K \text{/} N ⌋} ( {\sum }_{l = 0}^{⌊ L / M ⌋ - 1} {\sum }_{k = 0}^{⌊ K / N ⌋ - 1} {\vert \frac{\sqrt{{β}_{lM + m}}}{MN} {\sum }_{m = 0}^{M - 1} {\sum }_{n = 0}^{N - 1} {\hat{h}}_{lM + m , kN + n} \vert}^{2} )$$

wherein P̅ represents the second signal power estimation, L represents the number of OFDM symbols carrying the RSs for calculating the RSRP, K represents the number of subcarriers carrying the RSs for calculating the RSRP, M represents the number of RSs in each coherence block in time domain, m represents a serial number of the RS in each coherence block in time domain, N represents the number of RSs in each coherence block in frequency domain, n represents a serial number of the RS in each coherence block in frequency domain, l represents a serial number of the RS OFDM symbol in time domain, k represents a serial number of the RS subcarrier in frequency domain, β_{lM+m} represents a coefficient of the (lM+m)^{th} RS OFDM symbol for compensating a gain of down-link chain, the gain of down-link chain refers to a gain of ĥ_{l,k} relative to the antenna port signal, ĥ_{lM+m,kN+n} represents the channel estimation value of the (lM+m)^{th} RS in time domain and the (kN+n)^{th} RS in frequency domain, and └•┘ represents round-down operation.

The noise power estimation value may be calculated by the noise power estimation unit 43 using the following equation:

$${δ}^{2} = \frac{MN}{MN - 1} ( \hat{P} - \overline{P} )$$

wherein δ² represents the noise power estimation value, \hat{P} represents the first signal power estimation value, P̅ represents the second signal power estimation value, M represents the number of RSs in each coherence block in time domain, and N represents the number of RSs in each coherence block in frequency domain.

The RSRP may be calculated by the RSRP determination unit 44 using the following equation:

RSRP=\hat{P}−δ²,

wherein δ² represents the noise power estimation value, and \hat{P} represents the first signal power estimation value.

The RSRP may also be calculated by the RSRP determination unit 44 using the following equation:

RSRP=P̅−δ²/MN

wherein δ² represents the noise power estimation value, P̅ represents the second signal power estimation value, M represents the number of RSs in each coherence block in time domain, and N represents the number of the RSs in each coherence block in frequency domain.

In the above embodiments, the RB consists of a plurality REs. For example, in the case of a normal cyclic prefix, each RB consists of 12 (the number of subcarriers)*7 (the number of symbols) REs, and in the case of an extended cyclic prefix, each RB consists of 12 (the number of subcarriers)*6 (the number of symbols) REs.

The above are merely the preferred embodiments. It should be noted that, a person skilled in the art may make further modifications and improvements without departing from the principle of the present invention, and these modifications and improvements shall also be considered as the scope of the present invention.

1. A method for calculating Reference Signal Received Power (RSRP), comprising:
calculating a first signal power estimation value, the first signal power estimation value being an average value of power of all received Reference Signals (RSs);
calculating a second signal power estimation value, the second signal power estimation value being an average value of power of all coherence blocks, and the power of each coherence block being power of an average value of the channel estimation for all the RSs in the coherence block;
determining a noise power estimation value according to the first signal power estimation value and the second signal power estimation value; and
determining the RSRP according to the first signal power estimation value and the noise power estimation value, or according to the second signal power estimation value and the noise power estimation value,
wherein the coherence block consists of all Resource Elements (REs) within coherence time and a coherence bandwidth, a size of the coherence block depends on a current wireless channel environment, or a minimum coherence block consisting of two adjacent RSs in frequency domain is used.

2. The method according to claim 1, wherein the first signal power estimation value is calculated using the following equation:
$$\hat{P} = \frac{1}{LK} ( {\sum }_{l = 0}^{L - 1} {β}_{l} {\sum }_{k = 0}^{K - 1} {\vert {\hat{h}}_{l , k} \vert}^{2} )$$
wherein \hat{P} represents the first signal power estimation value, L represents the number of OFDM symbols carrying the RSs for calculating the RSRP, K represents the number of subcarriers carrying the RSs for calculating the RSRP, K=2N_{RB}, N_{RB} represents the number of RBs in frequency domain for calculating the RSRP, l represents a serial number of the RS OFDM symbol in time domain, k represents a serial number of the RS subcarrier in frequency domain, βₗ represents a coefficient of the l^{th} RS OFDM symbol for compensating a gain of down-link chain, the gain of down-link chain refers to a gain of ĥ_{l,k} relative to an antenna port signal, and ĥ_{l,k} represents the channel estimation value of the l^{th} RS in time domain and the k^{th} RS in frequency domain.

3. The method according to claim 1, wherein the second signal power estimation value is calculated using the following equation:
$$\overline{P} = \frac{1}{⌊ L \text{/} M ⌋ ⌊ K \text{/} N ⌋} ( {\sum }_{l = 0}^{⌊ L / M ⌋ - 1} {\sum }_{k = 0}^{⌊ K / N ⌋ - 1} {\vert \frac{\sqrt{{β}_{lM + m}}}{MN} {\sum }_{m = 0}^{M - 1} {\sum }_{n = 0}^{N - 1} {\hat{h}}_{lM + m , kN + n} \vert}^{2} )$$
wherein P̅ represents the second signal power estimation, L represents the number of Orthogonal Frequency Division Multiplexing (OFDM) symbols carrying the RSs for calculating the RSRP, K represents the number of subcarriers carrying the RSs for calculating the RSRP, M represents the number of RSs in each coherence block in time domain, m represents a serial number of the RS in each coherence block in time domain, N represents the number of RSs in each coherence block in frequency domain, n represents a serial number of the RS in each coherence block in frequency domain, l represents a serial number of the RS OFDM symbol in time domain, k represents a serial number of the RS subcarrier in frequency domain, β_{lM+m} represents a coefficient of the (lM+m)^{th} RS OFDM symbol for compensating a gain of down-link chain, the gain of down-link chain refers to a gain of ĥ_{l,k} relative to the antenna port signal, ĥ_{lM+m,kN+n} represents the channel estimation value of the (lM+m)^{th} RS in time domain and the (kN+n)^{th} RS in frequency domain, and └•┘ represents round-down operation.

4. The method according to claim 1, wherein in the step of determining the noise power estimation value according to the first signal power estimation value and the second signal power estimation value, the noise power estimation value is calculated using the following equation:
$${δ}^{2} = \frac{MN}{MN - 1} ( \hat{P} - \overline{P} )$$
wherein δ² represents the noise power estimation value, \hat{P} represents the first signal power estimation value, P̅ represents the second signal power estimation value, M represents the number of RSs in each coherence block in time domain, and N represents the number of RSs in each coherence block in frequency domain.

5. The method according to claim 1, wherein in the step of determining the RSRP according to the first signal power estimation value and the noise power estimation value, the RSRP is calculated using the following equation:
RSRP=\hat{P}−δ²
wherein δ² represents the noise power estimation value, and \hat{P} represents the first signal power estimation value.

6. The method according to claim 1, wherein in the step of determining the RSRP according to the second signal power estimation value and the noise power estimation value, the RSRP is calculated using the following equation:
RSRP=P̅−δ²/MN
wherein δ₂ represents the noise power estimation value, P̅ represents the second signal power estimation value, M represents the number of RSs in each coherence block in time domain, and N represents the number of the RSs in each coherence block in frequency domain.

7. A device for calculating Reference Signal Received Power (RSRP), comprising:
a first calculation unit, configured to calculate a first signal power estimation value, the first signal power estimation value being an average value of power of all received Reference Signals (RSs);
a second calculation unit, configured to calculate a second signal power estimation value, the second signal power estimation value being an average value of power of all coherence blocks, and the power of each coherence block being power of an average value of the channel estimation for all the RSs in the coherence block;
a noise power estimation unit, configured to determine a noise power estimation value according to the first signal power estimation value and the second signal power estimation value; and
an RSRP determination unit, configured to determine the RSRP according to the first signal power estimation value and the noise power estimation value, or according to the second signal power estimation value and the noise power estimation value,
wherein the coherence block consists of all Resource Elements (REs) within coherence time and a coherence bandwidth, a size of the coherence block depends on a current wireless channel environment, or a minimum coherence block consisting of two adjacent RSs in frequency domain is used.

8. The device according to claim 7, wherein the first calculation unit is configured to calculate the first signal power estimation value by using the following equation:
$$\hat{P} = \frac{1}{LK} ( {\sum }_{l = 0}^{L - 1} {β}_{l} {\sum }_{k = 0}^{K - 1} {\vert {\hat{h}}_{l , k} \vert}^{2} )$$
wherein \hat{P} represents the first signal power estimation value, L represents the number of OFDM symbols carrying the RSs for calculating the RSRP, K represents the number of subcarriers carrying the RSs for calculating the RSRP, K=2N_{RB}, N_{RB} represents the number of RBs in frequency domain for calculating the RSRP, l represents a serial number of the RS OFDM symbol in time domain, k represents a serial number of the RS subcarrier in frequency domain, βₗ represents a coefficient of the l^{th} RS OFDM symbol for compensating a gain of down-link chain, the gain of down-link chain refers to a gain of ĥ_{l,k} relative to an antenna port signal, and ĥ_{l,k} represents the channel estimation value of the l^{th} RS in time domain and the k^{th} RS in frequency domain.

9. The device according to claim 7, wherein the second calculation unit is configured to calculate the second signal power estimation value by using the following equation:
$$\overline{P} = \frac{1}{⌊ L \text{/} M ⌋ ⌊ K \text{/} N ⌋} ( {\sum }_{l = 0}^{⌊ L / M ⌋ - 1} {\sum }_{k = 0}^{⌊ K / N ⌋ - 1} {\vert \frac{\sqrt{{β}_{lM + m}}}{MN} {\sum }_{m = 0}^{M - 1} {\sum }_{n = 0}^{N - 1} {\hat{h}}_{lM + m , kN + n} \vert}^{2} )$$
wherein P̅ represents the second signal power estimation, L represents the number of OFDM symbols carrying the RSs for calculating the RSRP, K represents the number of subcarriers carrying the RSs for calculating the RSRP, M represents the number of RSs in each coherence block in time domain, m represents a serial number of the RS in each coherence block in time domain, N represents the number of RSs in each coherence block in frequency domain, n represents a serial number of the RS in each coherence block in frequency domain, l represents a serial number of the RS OFDM symbol in time domain, k represents a serial number of the RS subcarrier in frequency domain, β_{lM+m} represents a coefficient of the (lM+m)^{th} RS OFDM symbol for compensating a gain of down-link chain, the gain of down-link chain refers to a gain of ĥ_{l,k} relative to the antenna port signal, ĥ_{lM+m,kN+n} represents the channel estimation value of the (lM+m)^{th} RS in time domain and the (kN+n)^{th} RS in frequency domain, and └•┘ represents round-down operation.

10. The device according to claim 7, wherein the noise power estimation unit is configured to calculate the noise power estimation value by using the following equation:
$${δ}^{2} = \frac{MN}{MN - 1} ( \hat{P} - \overline{P} )$$
wherein δ² represents the noise power estimation value, \hat{P} represents the first signal power estimation value, P̅ represents the second signal power estimation value, M represents the number of RSs in each coherence block in time domain, and N represents the number of RSs in each coherence block in frequency domain.

11. The device according to claim 7, wherein the RSRP determination unit is configured to calculate the RSRP by using the following equation:
RSRP=\hat{P}−δ²
wherein δ² represents the noise power estimation value, and \hat{P} represents the first signal power estimation value.

12. The device according to claim 7, wherein the RSRP determination unit is configured to calculate the RSRP by using the following equation: [symbol]
